(19) United States
(12) Patent Application Publication
(10) Pub. No.: US 2009/0107633 A1
(43) Pub. Date: Apr. 30, 2009

(54) Apparatus and Method for Transferring, Apparatus and Method for Peeling, and Apparatus and Method for Laminating

(75) Inventors: Koichi Yamaguchi, Tokyo (JP); Takeshi Akechi, Tokyo (JP); Yoshiaki Sugishita, Tokyo (JP)

Correspondence Address: NORRIS, MCLAUGHLIN & MARCUS, P.A., 875 THIRD AVE, 18TH FLOOR, NEW YORK, NY, 10022, US

(73) Assignee: LINTEC CORPORATION, Tokyo (JP)

(21) Appl. No.: 11/916,582

(22) PCT Filed: May 23, 2006
(86) PCT No.: PCT/JP2006/310184

§ 371 Date: Dec. 5, 2007

(30) Foreign Application Priority Data
Jun. 6, 2005 (JP) 2005-166064

(51) Int. Cl. B29C 63/00

(52) U.S. Cl. 156/344; 156/584

(57) ABSTRACT

An apparatus and method for peeling, and an apparatus and method for laminating which are preferable to reduce the overall size of the apparatus are provided. When a transport means 8 transports a wafer W with glass plate G, and a holding roller 2, in synchronization with the transportation, rotates around its central axis, the holding roller 2 contacts the wafer W to peel it and hold it thereon, and after the peeling is completed, the transport means 8 transports a ring frame F in a direction opposite to the direction for peeling. In synchronization with the transportation, the holding roller 2 rotates around its central axis in a direction opposite to the direction for peeling, so that the holding roller 2 sticks the wafer W held on the holding roller to the ring frame F by means of a dicing tape T2.

### TECHNICAL FIELD

The present invention relates to an apparatus and method for transferring, an apparatus and method for peeling, and an apparatus and method for laminating which perform a series of operations including a peeling a plate-like member stuck to a supporting member and a lamination of the peeled plate-like member to another supporting member.

### BACKGROUND ART

Conventionally, an apparatus having a configuration described in Patent Document 1 is known as a peeling apparatus of this type. This patent discloses a peeling apparatus which peels a plate-like member stuck to a supporting member, specifically a polarizing plate (P) stuck to a separating film (SF), and a peeling method in which the separating film (SF) is adhered to a sticky roller at a suction stage (21) for winding up (see FIG. 3 and the description [0018] in the above-described Patent Document 1, for example). The above parenthesized numbers in description are used as in the Patent Document 1.

In the above peeling apparatus having the conventional configuration, however, the sticky roller (22) winds up an unnecessary supporting member to be discarded, that is the separating film (SF), remaining a polarizing plate (P) as a supporting member on the suction stage (21), because a technical idea to peel the polarizing plate (P) for winding is not incorporated therein. This configuration separately requires a laminating apparatus to stick the polarizing plate (P) on the suction stage (21) to a liquid crystal display, which inevitably enlarges the overall size of a transferring apparatus to perform a series of operations from peeling to lamination.

Patent Document 1: Japanese Patent No. 3053244

### DISCLOSURE OF THE INVENTION

### Problem to be Solved by the Invention

The present invention is made in view of the above problems, and it is an object of the present invention to provide an apparatus and method for transferring, an apparatus and method for peeling, and an apparatus and method for laminating which are preferable to reduce the overall size of the apparatus.

### Means for Solving the Problem

To accomplish the above object, the present invention provides a transferring apparatus which peels a plate-like member stuck to a first supporting member and sticks the plate-like member to a second supporting member, wherein the transferring apparatus comprises: a rotatable holding roller having an arc-shaped outer circumferential surface which is capable of holding the plate-like member; and transport means to transport a first and/or second supporting member in a direction tangent to the outer circumference of the holding roller, and wherein when the transport means transports the plate-like member stuck to the first supporting member, and the holding roller, in synchronization with the transportation, rotates around its central axis, the holding roller contacts the plate-like member to peel it from the first supporting member and hold it thereon, and when the transport means transports the second supporting member in a direction opposite to the direction for peeling after the peeling is completed, and the holding roller, in synchronization with the transportation, rotates around its central axis in a direction opposite to the direction for peeling, the holding roller sticks the plate-like member held on the holding roller to the second supporting member.

In the transferring apparatus according to the present invention, the holding roller is a suction roller which has an outer circumferential surface provided with a plurality of suction ports, so that the holding roller may contact the plate-like member to hold the plate-like member thereon by suction power through the suction ports for peeling of the plate-like member from the first supporting member and lamination of the plate-like member to the second supporting member.

In the transferring apparatus according to the present invention, the holding roller is a suction roller which has an outer circumferential surface provided with a plurality of suction ports, so that the holding roller may suck a non-adhesive coated surface of an adhesive sheet and an opposite adhesive coated surface of the adhesive sheet may contact the plate-like member to hold the plate-like member thereon by adhesion of the adhesive coated surface for peeling of the plate-like member from the first supporting member and lamination of the plate-like member to the second supporting member.

In the transferring apparatus according to the present invention, the first supporting member is a glass plate and the second supporting member is a ring frame, and the plate-like member may be a semiconductor wafer.

In the transferring apparatus according to the present invention, the second supporting member is a ring frame which an adhesive sheet is stuck beforehand thereto, and the plate-like member is a semiconductor wafer, so that the semiconductor wafer held on the holding roller may be stuck to the ring frame by means of the adhesive sheet.

In the transferring apparatus according to the present invention, the first supporting member may be a release liner, and the plate-like member may be a self-adhesive label.

In the transferring apparatus according to the present invention, before the plate-like member is peeled, a cue profile may be formed in the plate-like member.

The present invention provides a peeling apparatus to peel a plate-like member which is stuck to a supporting member, wherein the peeling apparatus includes a rotatable holding roller having an arc-shaped outer circumferential surface which is capable of holding the plate-like member and transport means which transports the supporting member in a direction tangent to an outer circumference of the holding roller, so that when the transport means transports the plate-like member stuck to the supporting member, and the holding roller, in synchronization with this transportation, rotates around its central axis, the holding roller contacts the plate-like member to peel the plate-like member from the supporting member and hold it thereon.

In the peeling apparatus according to the present invention, the holding roller is a suction roller which has an outer circumferential surface provided with a plurality of suction ports, so that the holding roller may contact the plate-like member to hold the plate-like member thereon and peel the plate-like member from a supporting member by suction power through the suction ports.

In the peeling apparatus according to the present invention, the holding roller is a suction roller which has an outer circumferential surface provided with a plurality of suction ports, so that the holding roller may suck a non-adhesive coated surface of an adhesive sheet and an opposite adhesive coated surface of the adhesive sheet may contact the plate-like member to hold the plate-like member thereon and peel the plate-like member from a supporting member by adhesion of the adhesive coated surface.

In the peeling apparatus according to the present invention, the supporting member may be a glass sheet, and the plate-like member may be a semiconductor wafer.

In the peeling apparatus according to the present invention, the supporting member may be a release liner, and the plate-like member may be a self-adhesive label.

In the peeling apparatus according to the present invention, a cue profile for peeling may be formed before the plate-like member is peeled.

The present invention provides a laminating apparatus to stick a plate-like member to an adherend, wherein it includes a rotatable holding roller having an arc-shaped outer circumferential surface which is capable of holding the plate-like member and transport means which transports the adherend in a direction tangent to the outer circumference of the holding roller, so that when the transport means transports the adherend, and the holding roller, in synchronization with this transportation, rotates around its central axis, the laminating apparatus sticks a plate-like member held on the holding roller to the adherend.

In the laminating apparatus according to the present invention, the adherend is a ring frame which an adhesive sheet is stuck beforehand thereto, and the plate-like member is a semiconductor wafer, so that the semiconductor wafer held on the holding roller may be stuck to the ring frame by means of the adhesive sheet.

The present invention provides a transferring method to peel a plate-like member stuck to a first supporting member and stick the plate-like member to a second supporting member, wherein the method uses: a rotatable holding roller having an arc-shaped outer circumferential surface which is capable of holding the plate-like member; and transport means which transports a first and/or second supporting member in a direction tangent to an outer circumference of the holding roller, and wherein the transferring method comprises: a step of peeling the plate-like member from the first supporting member to hold the plate-like member on the holding roller by contacting the holding roller with the plate-like member when the transport means transports the plate-like member stuck to the first supporting member, and the holding roller, in synchronization with the transportation, rotates around its central axis; and a step of laminating the plate-like member held on the holding roller to the second supporting member by the holding roller when the transport means transports the second supporting member in a direction opposite to the direction for peeling after the peeling is completed, and the holding roller, in synchronization with the transportation, rotates around its central axis in a direction opposite to the direction for peeling.

The present invention provides a peeling method to peel a plate-like member stuck to a supporting member, wherein the peeling method uses: a rotatable holding roller having an arc-shaped outer circumferential surface which is capable of holding the plate-like member; and transport means which transports the supporting member in a direction tangent to an outer circumference of the holding roller, and wherein the peeling method comprises: a step of peeling the plate-like member from the supporting member to hold the plate-like member on the holding roller by contacting the holding roller with the plate-like member when the transport means transports the plate-like member stuck to the supporting member, and the holding roller, in synchronization with the transportation, rotates around its central axis.

The present invention provides a laminating method to stick a plate-like member to an adherend, wherein the laminating method uses: a rotatable holding roller having an arc-shaped outer circumferential surface which is capable of holding the plate-like member; and transport means which transports the adherend in a direction tangent to an outer circumference of the holding roller, and wherein the laminating method comprises: a step of laminating the plate-like member held on the holding roller to the adherend when the transport means transports the adherend and the holding roller, in synchronization with the transportation, rotates around its central axis.

### EFFECT OF THE INVENTION

The above apparatus and method for transferring according to the present invention have a configuration in which a holding roller peels a plate-like member from a first supporting member to hold the plate-like member on the holding roller and sticks the plate-like member held on the holding roller to a second supporting member after the peeling is completed. Thus, one holding roller performs the both operations of peeling and lamination, which reduces the overall size of the apparatus to perform a series of operations from peeling to lamination.

The above apparatus and method for transferring according to the present invention have a configuration in which a holding roller peels a plate-like member from a supporting member to hold the plate-like member on the holding roller. Thus, the plate-like member may be peeled in a simple configuration, which may provide a compact peeling apparatus.

The above apparatus and method for transferring according to the present invention have a configuration in which a plate-like member held on a holding roller is stuck to the adherend. Thus, the plate-like member may be stuck in a simple configuration, which may provide a compact laminating apparatus.

### BEST MODE FOR CARRYING OUT THE INVENTION

Now, several preferred embodiments to practice the present invention will be explained with reference to the accompanying drawings.

FIG. 1 is a plane diagram to show a transferring apparatus according to the present invention; and FIG. 2 is a right side diagram to show a portion near the holding roller provided in the transferring apparatus of FIG. 1.

FIG. 1 shows a transferring apparatus 1 which peels a semiconductor wafer (a plate-like member) W (hereinafter, it is simply referred to as “wafer W”) stuck to a glass plate G (a first supporting member), and sticks the wafer W to a ring frame (a second supporting member) F, as shown in FIG. 2.

The transferring apparatus 1 includes a suction roller 2 as a holding roller. The suction roller 2 is rotatably supported to have a central axis parallel to X axis. The suction roller 2 also has an outer circumferential surface provided a plurality of open suction ports (not shown) to suck and hold a dicing tape T2 (an adhesive sheet) by the suction power through the ports. In the suction, a non-adhesive coated surface of the dicing tape T2 is stuck to an outer circumferential surface of the suction roller 2 remaining the adhesive coated surface of the dicing tape T2-1 being exposed outward to hold the wafer W.

The suction roller 2 is driven by a servo motor 7 for driving the suction roller by way of a pulley 5 and a belt 6. This suction roller driving system 5, 6, 7, and the suction roller 2 are, as shown in FIG. 2, configured to be movable vertically in the Z axis direction between the position to suck and hold the dicing tape T2 and the position to peel or stick the wafer W by a lifting means X1 via a frame F1. As shown specifically in FIG. 9, the suction roller 2 has an outer circumferential surface which includes an area 2A having a smaller diameter than the outer diameter of a dicing tape T2 and having a plurality of suction ports therein to suck and attract the dicing tape T2 to the area 2A.

A transport table (transport means) 8 is provided below the suction roller 2. The transport table 8 is a double table configuration consisting of a Y axis table 801 and an X axis table 802, and is configured to be movable in the Y axis direction, that is, in a direction tangent to an outer circumference of the suction roller 2, and to be movable in the X axis direction, that is, in a direction orthogonal to the tangent to the outer circumference of the suction roller 2. The transport table 8 is reciprocatable between a stand-by position S1 which is located at the front of the suction roller 2 and a working area S2 which is located back to the suction roller 2 after passing below the suction roller 2 by a movement in the Y axis direction. The movement of the transport table 8 in the Y axis direction is performed with a Y axis rail 803, a Y axis slider 804, and a single axis robot in the Y axis direction (now shown), and the movement of the transport table 8 in the X axis direction is performed with an X axis rail 805, an X axis slider 806, and a single axis robot in the X axis direction 807.

A multi-joint robot 9 is provided at the front of the stand-by position S1 of the transport table 8. The multi-joint robot 9 has an arm with a tip portion of the most distal joint which includes a wafer sucking arm 901 and a ring frame sucking arm 902. The multi-joint robot 9 works as follows.

(1) Using the wafer sucking arm 901, the multi-joint robot 9 takes out a wafer W stuck to a glass plate G using a ultra-violet curable double-faced adhesive tape (now shown) (hereinafter, referred to as “a wafer W with a glass plate G”) from a wafer cassette 11 on a lifting table 10 which is movable in the Z axis direction, and sets it on an alignment table 120 of an alignment equipment 12.

(2) Using the wafer sucking arm 901, the multi-joint robot 9 takes out the wafer W with a glass plate G from the alignment equipment 12 after alignment, and sets it on a transport table 130 of a ultra-violet irradiation device 13.

(3) Using the wafer sucking arm 901, the multi-joint robot 9 takes out the wafer W with a glass plate G from the ultra-violet irradiation device 13 after ultra-violet irradiation, and sets it on the transport table 8.

(4) Using the ring frame sucking arm 902, the multi-joint robot 9 carries the wafer W mounted on a ring frame to a wafer cassette 15 on the lifting table 14 and loads the wafer W therein.

In the alignment equipment 12, when the wafer W with a glass plate G is set on the alignment table 120, an orientation flat or V notch of the wafer W is detected by a camera 121 to modify the posture of the wafer W with a glass plate G into an adequate one and detect the position of its center.

In the ultra-violet irradiation device 13, the wafer W with a glass plate G is set on the transport table 130 of this device, and when the wafer W is passed below an ultra-violet lamp 131, an ultra-violet beam passes through the glass plate G to be irradiated to the double-faced adhesive tape between the glass plate G and the wafer W so that the adhesion of the double-faced adhesive tape is reduced.

The transferring apparatus 1 is provided with a cutter blade 16. The cutter blade 16 is means to form a cue profile in peeling in order to peel a wafer W from a glass plate G, and is mounted movably in a vertical direction by being suspended from the above so that it does not interfere the moving transport table 8.

A dicing tape feeding device 17 is provided at the back of and obliquely above the suction roller 2. The dicing tape feeding device 17 is configured so that the rotation of a driving roller 170 causes a raw dicing tape T which is bridged from a raw dicing tape roll R in a direction toward a peel plate 171 to be driven in the direction toward the peel plate, and bending of the raw dicing tape T at an acute angle at the peel plate 171 causes a dicing tape T2 to be peeled from a release liner T1 to be supplied to the suction roller 2. The release liner T1 after the peeling of the dicing tape is wound into a roll to be collected. The dicing tape T2 has a diameter larger than that of a wafer W, and is temporarily stuck to a release liner T1 with an adhesive layer (not shown) being interposed between them.

In the working area S2 at the back of the suction roller 2, an operation of setting a ring frame F to the transport table 8 and an operation of removing a glass plate G from the transport table 8 are simultaneously performed. As means to perform the operations, a transport robot 18 having a ring frame suction pad 180 and a glass plate suction pad 181 is provided in the working area S2. The transport robot 18 consists of a single axis robot having an X axis slider 182 which is movable in the X axis direction, and includes up-and-down cylinders 183, 184 on both sides of the X axis slider 182. The up-and-down cylinder 183 on the left side of FIG. 1 is means to move the ring frame suction pad 180 up-and-down in the Z axis direction. The up-and-down cylinder 184 on the right side of FIG. 1 is means to move the glass plate suction pad 181 up-and-down in the Z axis direction. The transport robot 18 having the above configuration performs operations as follows.

(1) Using the ring frame suction pad 180, the transport robot 18 takes out a ring frame F from a ring frame stocker 19 and sets it on the transport table 8.

(2) Using the glass plate suction pad 181, the transport robot 18 carries a glass plate G after the peeling of a wafer on the transport table 8 to a glass stocker table 20.

A pair of ON/OFF sensors 21, 22 is provided at a position which is opposed to the outer circumferential surface of the suction roller 2 and is separated by a predetermined space from the outer circumferential surface of the suction roller 2. The pair of ON/OFF sensors 21, 22 as shown in FIG. 3, is placed parallel to each other at an arrangement distance D which is shorter than the diameter of a wafer W, from a reference center line C1 of a wafer W on the transport table 8. Both of the ON/OFF sensors 21, 22 monitor the outer circumferential surface of the suction roller 2 at points from the side of the working area S2 (see FIG. 2), and output an ON or OFF signal depending on the entrance of the wafer W held on the suction roller 2 into a monitoring point and the passing over the monitoring point. Specifically, when the wafer W held on the suction roller 2 enters the monitoring point, the pair of ON/OFF sensors 21, 22 output an ON signal, and when the wafer W passes over the monitoring point, the pair of ON/OFF sensors 21, 22 output an OFF signal. The output signals (ON signal, OFF signal) from the ON/OFF sensors 21, 22 are input to a control unit 23 including a personal computer shown in FIG. 2.

The control unit 23 (a control device for peeling and laminating) controls a series of the operations from peeling to lamination of a wafer, and has a function to output command signals to various devices in the transferring apparatus, for example by outputting a command signal for rotation to a suction roller driving servo motor 7 and a command signal for moving to the transport table 8, as well as a pulse count function, a chord length calculation function, a misalignment calculation function, a correcting function (correcting means), as shown in FIG. 12.

By the pulse count function of the control unit 23, a pulse per revolution of the suction roller driving servo motor 7 is counted between the ON signal and the OFF signal outputted from each sensor.

By the chord length calculation function of the control unit 23, as shown in FIG. 3, angles of rotation of the suction roller 2 which correspond to the counted number of the pulse per revolution are calculated, and then, based on the angles of rotation, chord lengths a, b of a wafer W held on the suction roller 2 is calculated; the chord length a in FIG. 3 is calculated based on the output signals from the sensor 21 on the left side of FIG. 3, and the chord length b in FIG. 3 is calculated based on the output signals from the sensor 22 on the right side of FIG. 3.

By the misalignment calculation function of the control unit 23, the lengths A, B in FIG. 3 are calculated by the following formulas (1) and (2), and a half of the difference between the length A and the length B is determined and stored as an misalignment C in the X axis direction relative to the center line C2 of a wafer W by the formula (3); where r in the following formulas (1) and (2) is the radius of a wafer W, and the value r in the formulas depends on the radius of a wafer W as needed.

A=(r²−(a/2)²)^{1/2} (1)

B=(r²−(b/2)²)^{1/2} (2)

C=(A−B)/2 (3)

The misalignment C in the X axis direction of a wafer W may be calculated by the following formula (4) using an arrangement_distance D between the ON/OFF sensors 21 and 22.

C=D−A, or C=D−B (4)

By the misalignment calculation function of the control unit 23 also, as shown in FIG. 4, the misalignment of the center of a wafer W from the center of attachment in a direction along the arc of the suction roller 2 (hereinafter, referred to as “a center misalignment angle θ”) is determined and stored by using the formulas of a/2 or b/2. The center of attachment is a reference position for lamination of a peeled wafer W to a ring frame F, and means a predetermined position to match the center of attachment with the center of a ring frame F. In this embodiment, since the center of attachment is located at a position parallel to the Y axis, which passes through in the center of the suction roller 2, the misalignment of the center of a wafer W calculated from a/2 or b/2 from the Y axis, which passes through in the center of the suction roller 2, in the direction along the arc of the suction roller 2 equals to the center misalignment angle θ. The center misalignment angle θ will be converted into a number of pulse revolutions of the suction roller driving servo motor 7 to be stored.

The correcting function of the control unit 23 in divided into two main functions; a correcting function to correct the misalignment in the X axis direction, and a correcting function to correct the center misalignment angle. These functions are as follows.

By the correcting function to correct the misalignment in the X axis direction, when a wafer W is peeled from a glass plate G with a misalignment C in the X axis direction, in order to eliminate the misalignment C in the X axis direction before transferring, the misalignment C in the X axis direction is calculated and a command is issued to a single axis robot 807 in the X axis direction to move the transport table 8 by the misalignment C for correction before lamination. A lamination of a wafer W to a ring frame F by means of a dicing tape T2 with the misalignment C in the X axis direction makes a subsequent dicing operation of the wafer W inadequate, but because of correcting the misalignment in the X axis direction in this embodiment, the dicing operation of the wafer W will be adequately performed.

Similarly, by the correcting function to correct the center misalignment angle, when a peeling of a wafer W from a glass plate G causes a misalignment angle θ between the center of the wafer W and a predetermined position of the suction roller 2 (a position parallel to the Y axis in this embodiment), in order to eliminate the misalignment before transferring, the misalignment angle θ is calculated for correction. That is, a misalignment is corrected in the direction of Y axis after lamination of a wafer W to a ring frame F. This correction is performed by displacing the starting point of a lamination to a ring frame F in consideration of the center misalignment angle θ. Alternatively, before the suction roller 2 starts an operation to stick, the misalignment angle θ may be advanced or retarded so that the center of the wafer W is located parallel to the Y axis to allow the wafer W to be stuck to a ring frame F. A lamination of a wafer W without consideration of the misalignment angle θ causes a misalignment in the Y axis direction between the center of the wafer W and the center of a ring frame F, which makes a subsequent dicing operation of the wafer W inadequate, but in this embodiment, a misalignment is corrected in the direction of Y axis before lamination of a wafer W to a ring frame F, the dicing operation of the wafer W will be adequately performed.

Now, the operation of the transferring apparatus of FIG. 1 which has a configuration described above will be explained with reference to FIG. 1 to FIG. 8.

<Alignment of a Wafer With Glass Plate>

Referring to FIG. 1, in the transferring apparatus 1, a wafer W with glass plate G is taken out from the wafer cassette 11 of FIG. 1 and is transported into the alignment equipment 12 to be aligned in the alignment equipment 12.

<Irradiation of Ultra-Violet>

After the alignment, the wafer W with glass plate G is transported into the ultra-violet irradiation device 13 where the adhesion of the ultra-violet curable double-faced adhesive tape which is placed between the glass plate G and the wafer W is lowered to make the peeling of the wafer W easier.

<Formation of a Cue Profile for Peeling>

As part of preparation for the peeling of the wafer W, an operation to form a cue profile for peeling is performed. Specifically, once the ultra-violet irradiation is completed, the wafer W with glass plate G is set for suction on the transport table 8 which is located at a stand by position S1. A cutter blade 16 is shifted by a shifting mechanism (not shown) to the wafer W with glass plate G on the transport table 8, and a cutting edge of the cutter blade 16 is inserted between the wafer W and the ultra-violet curable double-faced adhesive tape from the side of the outer circumferential surface of the wafer W with glass plate G to make a cut as a cue profile for peeling (see Japanese Patent Application No. 2004-237332 for detail).

<Setting of Dicing Tape>

Also as part of preparation for the peeling of the wafer W, an operation to set a dicing tape T2 to the suction roller 2 is performed. Specifically, as shown in FIG. 2, the suction roller 2 is rotated by a predetermined angle in a direction indicated by an arrow CC to a position to suck and hold a dicing tape T2, and in synchronization with this rotation, a sheet of dicing tape T2 is fed to the outer circumferential surface of the suction roller 2 from the dicing tape feeding device 17. Then, the dicing tape T2 is sucked to the outer circumferential surface by the suction power of the suction roller to be held thereon. The outer circumferential surface of the suction roller 2 contacts the non-adhesive surface of the dicing tape T2 to make the adhesive coated surface of the dicing tape T2 outwardly exposed.

<Peeling of Wafer>

After the preparation of the peeling described above, an operation to peel the wafer W from the wafer W with glass plate G is performed. Specifically, as shown in FIG. 5, the transport table 8 at the stand-by position S1 transports the wafer W with glass plate G toward the suction roller 2. When the sensors detect that the transport table 8 reaches a predetermined position (not shown), the suction roller 2 is lowered by the lifting means X1, and in synchronization with the transportation of the transport table 8, the suction roller 2 is rotated in the direction indicated by an arrow CC in FIG. 5 to gradually peel the wafer W and hold it thereon using the adhesive coated surface T2-1 of the dicing tape T2. That is, when the adhesive coated surface T2-1 of the dicing tape T2 contacts the wafer W, the wafer W is held by the adhesion. After the peeling, the suction roller 2 is stopped rotating at the position after the rotation of a predetermined angle, and the suction roller 2 is lifted by the lifting means X1 to stand by. FIG. 6 shows this state.

<Setting of Ring Frame>

When the peeling of the wafer W is completed as described above, next preparation is started to stick the wafer W to a ring frame F. Specifically, as shown in FIG. 7, the transport table 8 is advanced to the working area S2 to enable the transport robot 18 to remove the glass plate from above the transport table 8 and to set a ring frame F at the same time.

<Alignment of Wafer>

As part of preparation for the lamination of the wafer W, an operation to align the wafer W held on the suction roller 2 is performed. As described above, this alignment determines a misalignment of the wafer W in the X axis direction and a center misalignment angle θ of the wafer W.

<Lamination of Wafer>

After the above alignment is completed, an operation to stick the wafer W to a ring frame F by means of a dicing tape T2 is performed. Specifically, as shown in FIG. 8, the transport table 8 at the working area S2 transports the ring frame F in a direction opposite to that for the peeling. In synchronization with the transportation, the suction roller 2 is rotated in a direction opposite to that for the peeling (a direction indicated an arrow CW in FIG. 8). This makes the wafer held on the suction roller 2 stuck to a ring frame F by means of the dicing tape T2. In this lamination, the misalignment of the wafer W in the X axis direction and the center misalignment angle θ of the wafer W determined in the alignment operation of the wafer are corrected. Specifically, the misalignment of the wafer W in the X axis direction is corrected by the single axis robot in the X axis direction 807, and the misalignment in the Y axis direction is corrected by displacing the starting point of a lamination by lowering of the lifting means X1 back and forth. This allows the wafer W to be stuck accurately to a ring frame F. This operation to stick the wafer F is progressed depending on the angle of rotation of the suction roller 2, and when the wafer W is mounted to a ring frame F by the lamination and the suction roller 2 is rotated by a predetermined angle, the suction roller 2 is stopped, and the lifting means X1 is lifted to return to its original position. Then, an operation to set a dicing tape is performed for next transferring, as described above.

The wafer W mounted to a ring frame F is received in the wafer cassette 15 with the ring frame F. This completes a series of transferring operations from peeling to lamination of one wafer W.

FIG. 10 is a diagram to illustrate an alternative transferring apparatus according to the present invention. In the transferring apparatus 1 of FIG. 10, a self-adhesive label (plate-like member) L which is stuck to a release liner (a first supporting member) K is peeled to be stuck to an object (a second supporting member) M to which the label is to be stuck. The transferring apparatus 1 basically has a configuration similar to that of transferring apparatus 1 of FIG. 1, and so the similar reference numerals are applied to the similar members, and the transferring apparatus 1 of FIG. 10 will not be explained herein in detail. The transferring apparatus 1 of FIG. 10 is different from the transferring apparatus 1 of FIG. 1 as follows.

In the transferring apparatus of FIG. 10, the outer circumferential surface of the suction roller 2 itself is adopted to peel the self-adhesive label L from the self-adhesive label L with a release liner K, and hold it thereon. The self-adhesive label L with a release liner K is an article in which the self-adhesive label L is temporarily stuck to a release liner K with an adhesive layer (not shown) of itself interposed between them.

In the transferring apparatus of FIG. 10, an operation to peel the self-adhesive label L from the self-adhesive label L with a release liner K, and an operation to stick the peeled self-adhesive label L to an object M to which the label is to be stuck, as described above, are basically similar to those for the transferring apparatus 1 of FIG. 1, which will be briefly explained below.

In the operation to peel, when the transport table 8 transports the self-adhesive label L with a release liner K, and the suction roller 2 is lowered at a predetermined position, and in synchronization with the transportation of the transport table 8, is rotated around its center axis, and is stopped rotating at the position after the rotation of a predetermined angle, the label L is peeled and held on the suction roller.

In the operation to stick, when the transport table 8 transports the object M to which the label is to be stuck in a direction opposite to that for peeling, and the suction roller is lowered at a predetermined position, and in synchronization with the transportation of the transport table 8, is rotated around its center axis in a direction opposite to that for peeling, the label L which is held on the suction roller 2 is stuck to the object M to which the label is to be stuck.

FIG. 11 is a diagram to illustrate a suction roller used in the transferring apparatus of FIG. 10, and the suction roller 2 has an outer circumferential surface which includes an area 2A slightly smaller than the self-adhesive label L with a plurality of suction ports, so that the area 2A sucks the self-adhesive label L and attaches it thereto. The suction roller 2 of FIG. 11 also includes a smaller area portion 2A-1 in the area 2A which is a sucking system independent from the remaining portion, so that a suction power sufficient to start peeling of the self-adhesive label L may work on the self-adhesive label L.

The transferring apparatus of FIG. 1 has a configuration in which a ring frame F without a dicing tape T2 being stuck thereto is transported by the transport table 8, but instead of this configuration, the transferring apparatus may have a configuration in which a ring frame F with a dicing tape T2 being stuck thereto is transported by the transport table 8 as shown in FIG. 13. In this case, the transferring apparatus may be configured so that before the transport robot 18 sets a ring frame F on the transport table 8, a dicing tape laminating apparatus sticks a dicing tape T2 to the ring frame F with an adhesive coated surface T2-1 facing upward to set the ring frame F on the transport table 8, and the wafer W is held by the outer circumferential surface of the suction roller 2 itself as shown in FIG. 13, as in the self-adhesive label L of FIG. 10. The wafer W held in this way is stuck to the ring frame F by means of the dicing tape T2 in a similar operation by the transferring apparatus of FIG. 1, that is, when the transport table 8 transports the ring frame F with a dicing tape T2, and suction roller 2, in synchronization with the transportation, rotates around its central axis.

### BRIEF DESCRIPTION OF THE DRAWINGS

FIG. 1 is a plane diagram to show a transferring apparatus according to the present invention;

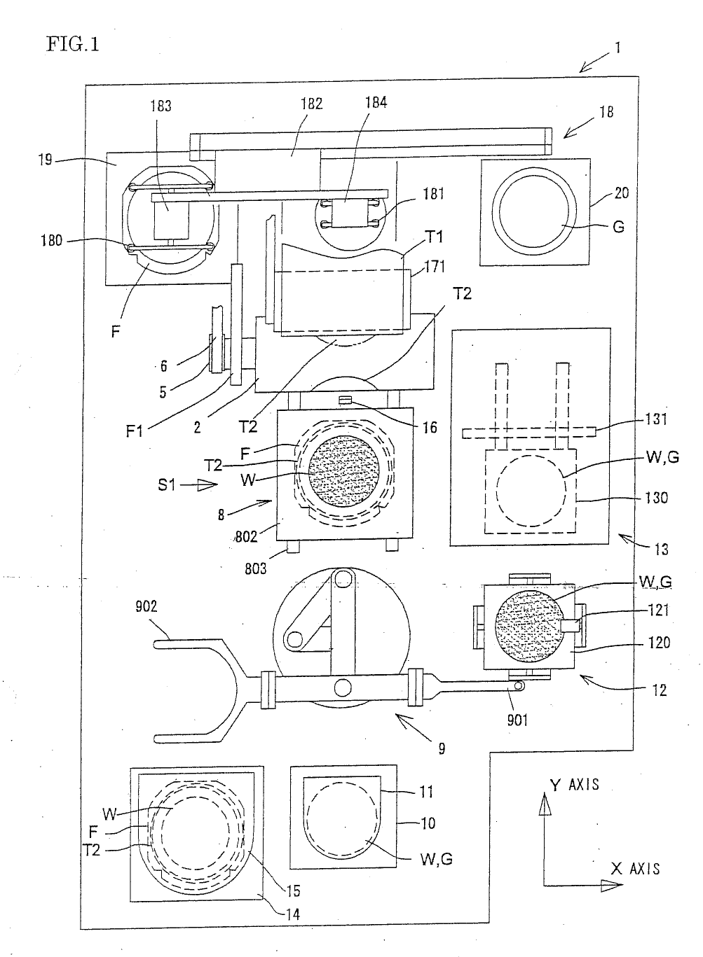

FIG. 2 is a right side diagram to show a portion near a suction roller provided in the transferring apparatus of FIG. 1;

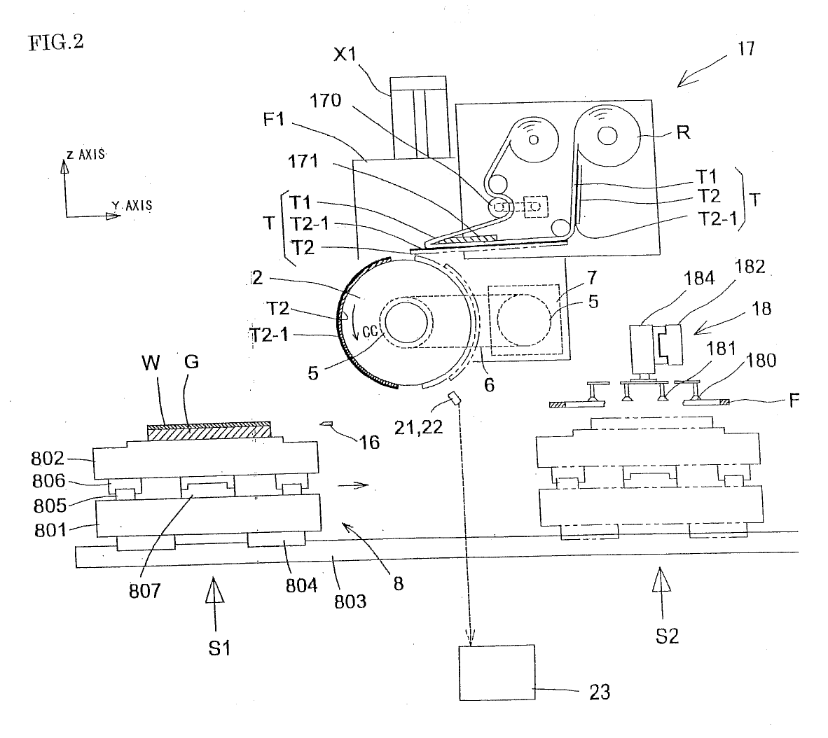

FIG. 3 is a diagram to illustrate a correction of a misalignment in the X axis direction in the transferring apparatus of FIG. 1;

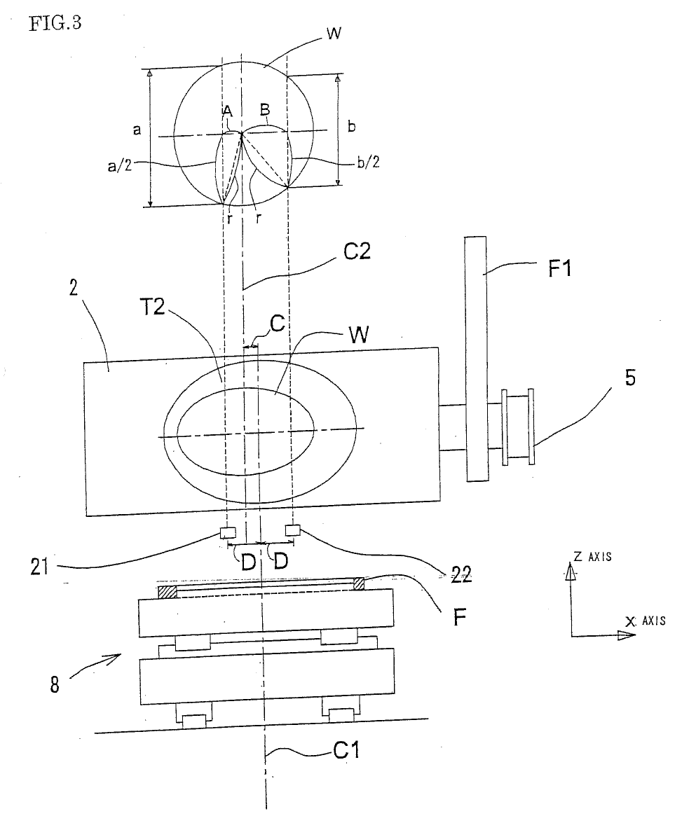

FIG. 4 is a diagram to illustrate a correction of a center misalignment angle in the transferring apparatus of FIG. 1;

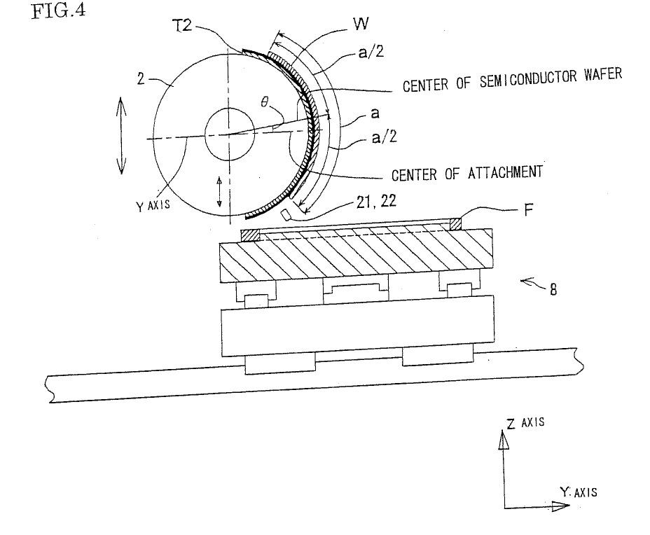

FIG. 5 is a diagram to illustrate an operation of the transferring apparatus of FIG. 1;

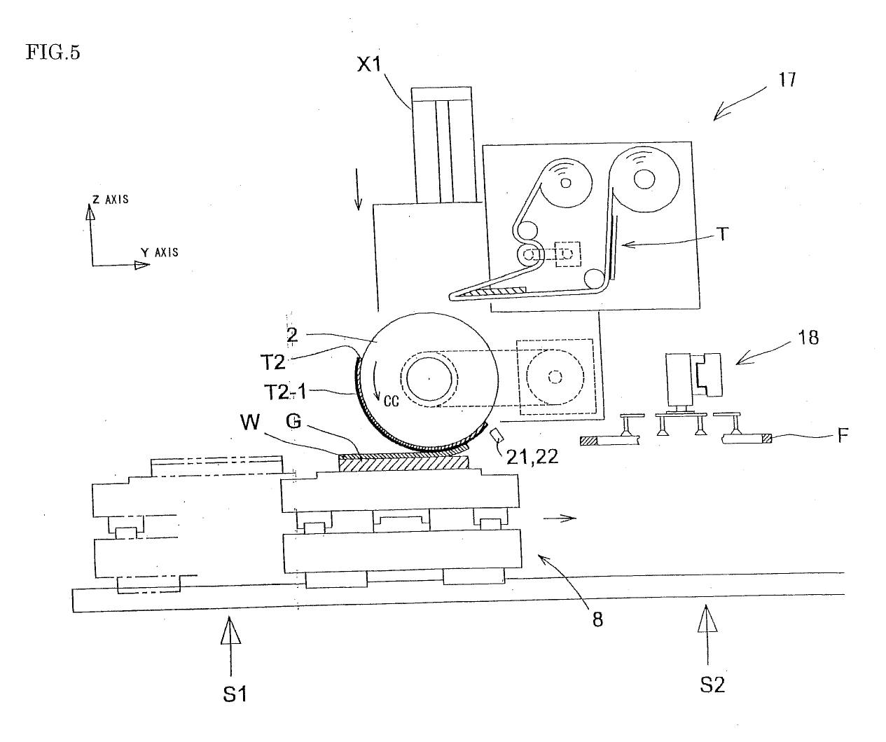

FIG. 6 is a diagram to illustrate an operation of the transferring apparatus of FIG. 1;

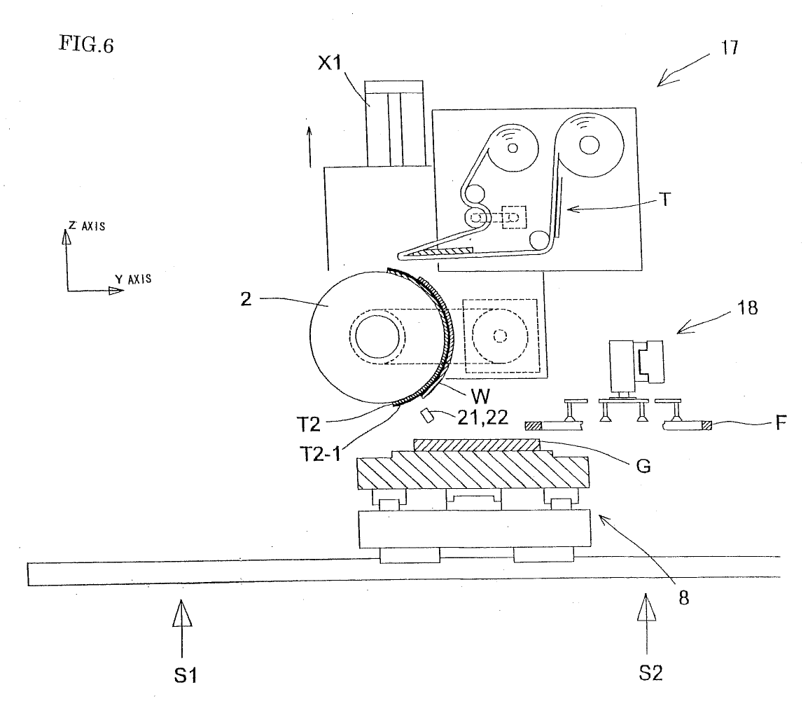

FIG. 7 is a diagram to illustrate an operation of the transferring apparatus of FIG. 1;

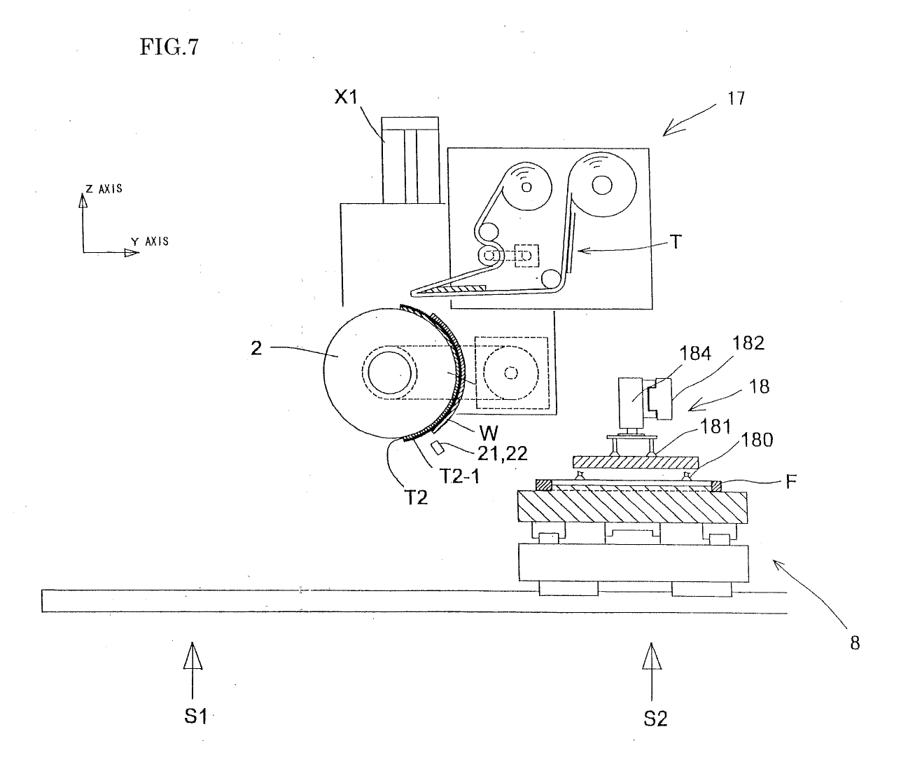

FIG. 8 is a diagram to illustrate an operation of the transferring apparatus of FIG. 1;

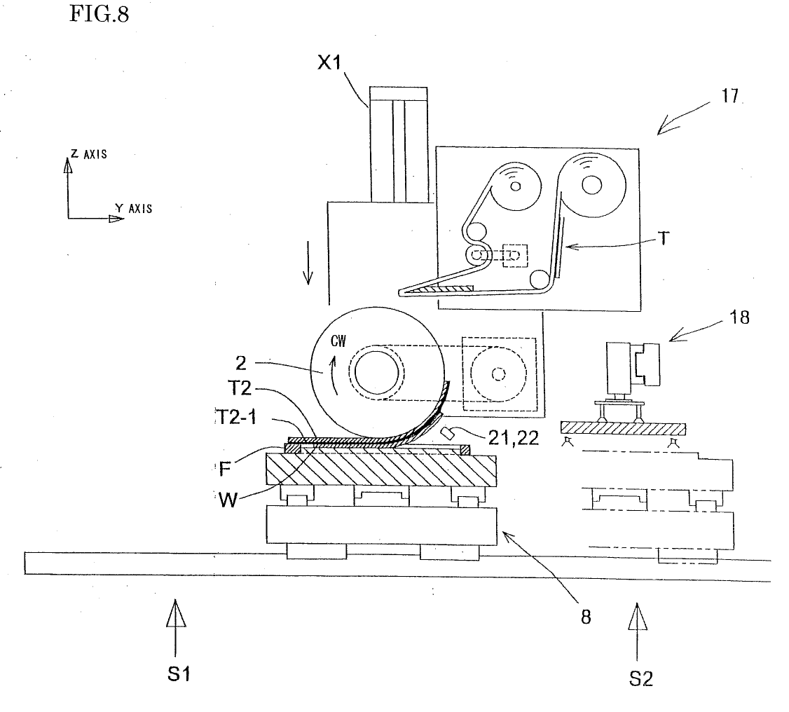

FIG. 9 is a diagram to illustrate a suction roller used in the transferring apparatus of FIG. 1;

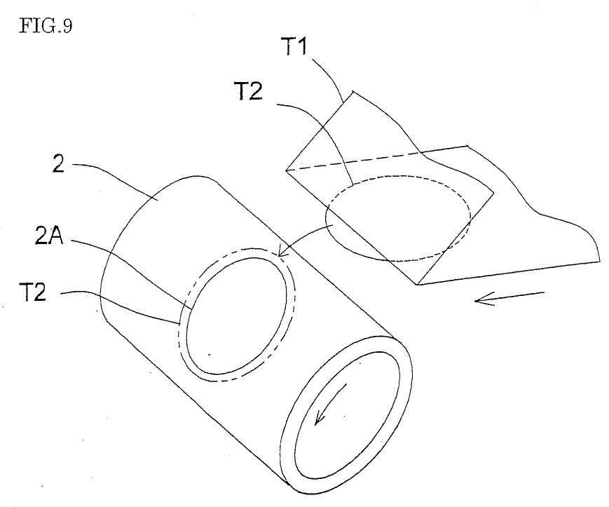

FIG. 10 is a diagram to illustrate an alternative transferring apparatus according to the present invention;

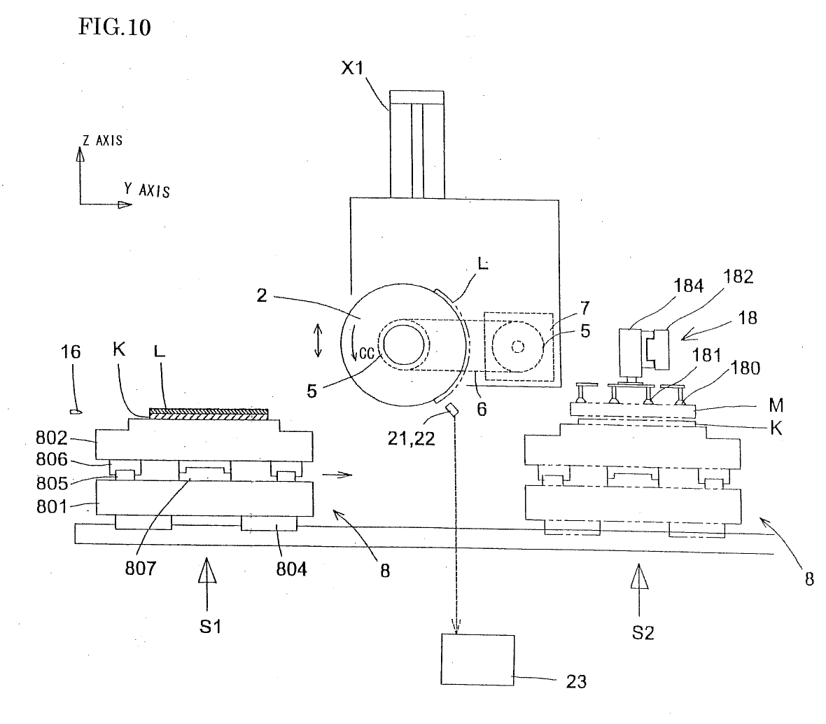

FIG. 11 is a diagram to illustrate a suction roller used in the transferring apparatus of FIG. 10;

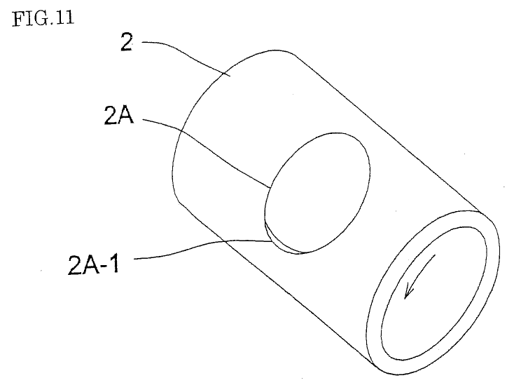

FIG. 12 is a block diagram to show a control unit; and

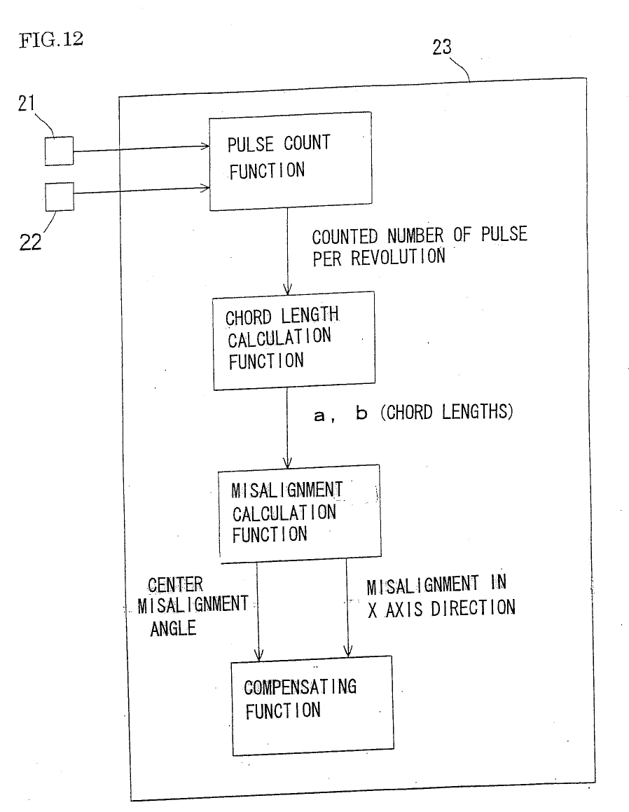

FIG. 13 is a diagram to illustrate an alternative transferring apparatus according to the present invention.

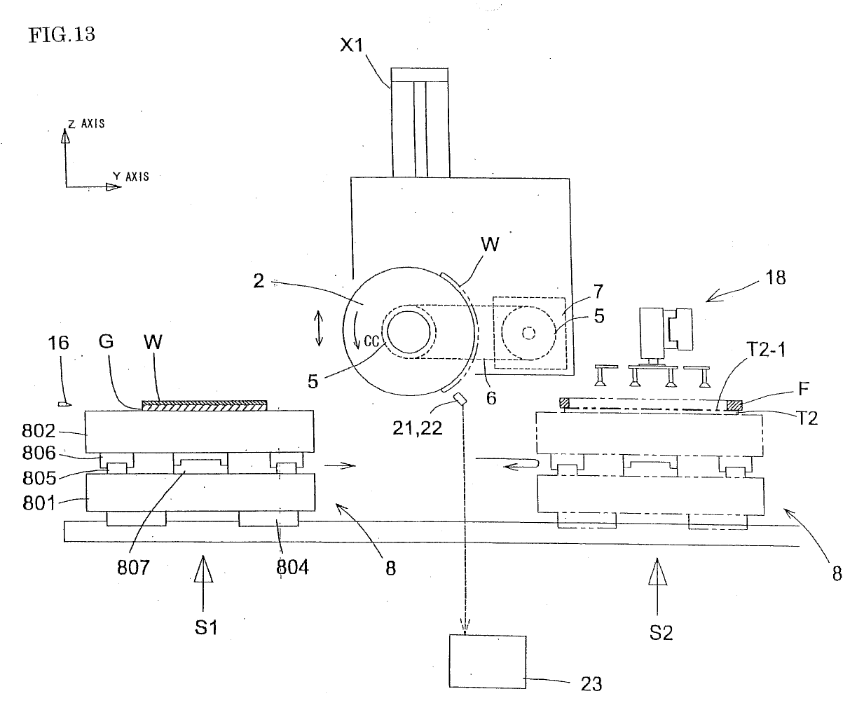

### EXPLANATION OF LETTERS OR NUMERALS

1. transferring apparatus

2. suction roller (holding roller)

8. transport table (transport means)

16. cutter blade

F. ring frame (second supporting member)

G. glass plate (first supporting member)

K. release liner (first supporting member)

L. self-adhesive label (plate-like member)

M. object to which the label is to be stuck (second supporting member)

T2. dicing tape (adhesive sheet)

T2-1. adhesive coated surface of dicing tape

W. wafer (plate-like member)

1. A transferring apparatus which peels a plate-like member stuck to a first supporting member and sticks the plate-like member to a second supporting member, wherein the transferring apparatus comprises:
a rotatable holding roller having an arc-shaped outer circumferential surface which is capable of holding the plate-like member; and
transport means to transport a first and/or second supporting member in a direction tangent to the outer circumference of the holding roller,
and wherein when the transport means transports the plate-like member stuck to the first supporting member, and the holding roller, in synchronization with the transportation, rotates around its central axis, the holding roller contacts the plate-like member to peel it from the first supporting member and hold it thereon, and when the transport means transports the second supporting member in a direction opposite to the direction for peeling after the peeling is completed, and the holding roller, in synchronization with the transportation, rotates around its central axis in a direction opposite to the direction for peeling, the holding roller sticks the plate-like member held on the holding roller to the second supporting member.

2. The transferring apparatus according to claim 1, wherein the holding roller is a suction roller which has an outer circumferential surface provided with a plurality of suction ports, so that the holding roller contacts the plate-like member to hold the plate-like member thereon by suction power through the suction ports for peeling of the plate-like member from the first supporting member and lamination of the plate-like member to the second supporting member.

3. The transferring apparatus according to claim 1, wherein the holding roller is a suction roller which has an outer circumferential surface provided with a plurality of suction ports, so that the holding roller sucks a non-adhesive coated surface of an adhesive sheet and an opposite adhesive coated surface of the adhesive sheet contacts the plate-like member to hold the plate-like member thereon by adhesion of the adhesive coated surface for peeling of the plate-like member from the first supporting member and lamination of the plate-like member to the second supporting member.

4. The transferring apparatus according to claim 3, wherein the first supporting member is a glass plate, the second supporting member is a ring frame, and the plate-like member is a semiconductor wafer.

5. The transferring apparatus according to claim 1, wherein the second supporting member is a ring frame which an adhesive sheet is stuck beforehand thereto and the plate-like member is a semiconductor wafer, and wherein the semiconductor wafer held on the holding roller is stuck to the ring frame by means of the adhesive sheet.

6. The transferring apparatus according to claim 1, wherein the first supporting member is a release liner, and the plate-like member is a self-adhesive label.

7. The transferring apparatus according to claim 1, wherein a cue profile for peeling is formed before the plate-like member is peeled.

8. A peeling apparatus to peel a plate-like member stuck to a supporting member, wherein the peeling apparatus comprises:
a rotatable holding roller having an arc-shaped outer circumferential surface which is capable of holding the plate-like member; and
transport means which transports the supporting member in a direction tangent to an outer circumference of the holding roller,
and wherein when the transport means transports the plate-like member stuck to the supporting member, and the holding roller, in synchronization with the transportation, rotates around its central axis, the holding roller contacts the plate-like member to peel the plate-like member from the supporting member and hold it thereon.

9. The peeling apparatus according to claim 8, wherein the holding roller is a suction roller which has an outer circumferential surface provided with a plurality of suction ports, so that the holding roller contacts the plate-like member to hold the plate-like member thereon and peel the plate-like member from the supporting member by suction power through the suction ports.

10. The peeling apparatus according to claim 8, wherein the holding roller is a suction roller which has an outer circumferential surface provided with a plurality of suction ports, so that the holding roller sucks a non-adhesive coated surface of an adhesive sheet and an opposite adhesive coated surface of the adhesive sheet contacts the plate-like member to hold the plate-like member thereon and peel the plate-like member from the supporting member by adhesion of the adhesive coated surface.

11. The peeling apparatus according to claim 8, wherein the supporting member is a glass plate, and the plate-like member is a semiconductor wafer.

12. The peeling apparatus according to claim 8, wherein the supporting member is a release liner, and the plate-like member is a self-adhesive label.

13. The peeling apparatus according to claim 8, wherein a cue profile for peeling is formed before the plate-like member is peeled.

14. (canceled)

15. (canceled)

16. A transferring method to peel a plate-like member stuck to a first supporting member and stick the plate-like member to a second supporting member, wherein the method uses:
a rotatable holding roller having an arc-shaped outer circumferential surface which is capable of holding the plate-like member; and
transport means which transports the first and/or second supporting member in a direction tangent to the outer circumference of the holding roller,
and wherein the transferring method comprises: a step of peeling the plate-like member from the first supporting member to hold the plate-like member on the holding roller by contacting the holding roller with the plate-like member when the transport means transports the plate-like member stuck to the first supporting member, and the holding roller, in synchronization with the transportation, rotates around its central axis; and a step of laminating the plate-like member held on the holding roller to the second supporting member by the holding roller when the transport means transports the second supporting member in a direction opposite to the direction for peeling after the peeling is completed, and the holding roller, in synchronization with the transportation, rotates around its central axis in a direction opposite to the direction for peeling.

17. (canceled)

18. (canceled)
